(19) United States
(12) Patent Application Publication
(10) Pub. No.: US 2002/0024958 A1
(43) Pub. Date: Feb. 28, 2002

(54) Messaging in H.323 networks at call setup

(76) Inventors: Espen Iveland, Drammen (NO); Anders Froyhaug, Nesoya (NO)

Correspondence Address: NIXON & VANDERHYE P.C., 8th Floor, 1100 North Glebe Rd., Arlington, VA, 22201-4714, US

(21) Appl. No.: 09/860,428

(22) Filed: Jul. 24, 2001

(30) Foreign Application Priority Data
May 19, 2000 (NO) 20002565

(51) Int. Cl. H04L 12/56

(52) U.S. Cl. 370/401; 709/203

(57) ABSTRACT

A method and apparatus in a H.323 based network to effect messaging from a message server to a calling subscriber prior to or during a usual call establishment. The calling subscriber sends a SETUP message to an associated Gatekeeper to request a call set-up. On receiving the request, the Gatekeeper searches a stored caller service profile for information regarding the messaging service. If the search is successful, the gatekeeper sends, on basis of the caller service profile information contents, a SETUP message to the message server, and the transfer of the message from the message server to the caller is effected. The originally requested call set-up is then completed according to known H.323 call set-up procedures.

### FIELD OF THE INVENTION

The invention relates to the field of messaging in multimedia telecommunication networks according to ITU-T standard H.323. More particularly, the invention provides a method and an arrangement to allow message sending during call establisment.

### THE PROBLEMS AREAS

In modem telecommunication networks, network operators or service providers may want to send messages to their subscribers for many reasons. Today, this is accomplished in a number of different ways, such as by means of e-mail, telefax or letter. Generally, the distribution of messages by such means is cumbersome, and requires active co-operation on the part of the addressee who will have to make specific actions for collecting and opening such messages in order to obtain the message contents.

There are, however, systems available today which can deliver messages to network subscribers without the need for actions to be erformed by the receiving subscriber. One example on how this is used is commercials being delivered during a telephone call. In PSTN/ISDN networks, some service providers even offer their customers lower charges or free calls if they accept commercial breaks during a phone call. Another example is the situation where a calling card subscriber is notified of her/his credit before the call starts.

Generally, if messages from the service provider could be a part of call establisment, this could provide a range of new services and possibilities. In addition, this option can provide possibilities for content providers that want to distibute information.

### KNOWS SOLUTIONS AND PROBLEMS WITH THESE

With regard to known systems, of which some examples have been given above, the types of messages and their contents have been quite limited, as the systems in which messaging on or after the call is established have been strongly limited to the type of information that those system are able to carry to the recipient in such situations.

Now, with the multimedia capabilities in H.323, messaging as a part of a phone call could be extended to include, in addition to audio, other information formats such as video and/or data.

A problem related to messaging during call setup of the types described above in H.323 based systems when compared to PSTN/ISDN systems, is the range of media formats supported by H.323 that are negotiated during call setup.

### OBJECTS OF THE INVENTION.

Accordingly, it is an object of the present invention to provide messaging during call setup and implementation of such in a H.323 network.

It is a further object of the present invention to provide a solution to the problem of messaging at call setup time in a H.323 network related to the media capabilities.

### BRIEF DISCLOSURE OF THE INVENTION.

Some of the above objects are met by a method according to the invention with the features of the accompanying independent claim 1, and further features as given in the accompanying dependent claims 2-4.

Further objectives are met by an apparatus according to the invention with the features of the accompanying independent claim 5, and further features as given in the accompanying dependent claim 6.

### DESCRIPTION OF THE DRAWINGS.

FIG. 1 is a simplified block schematic diagram illustrating a network view of a system including an implenetation of the present invention,

FIG. 2 is a signal sequence diagram illustrating signalling in a variant of a method according to the invention, and

FIG. 3 is a signal sequence diagram illustrating signalling in another variant of a method according to the invention.

### DETAILED DESCRIPTIONS OF THE EMBODIMENTS.

In the following the invention will be described by way of example and with reference to the accompaying drawings.

Generally, the present invention and embodiments thereof are based on and implemented in systems having H.323 version 2 and support for fast start (a media negotiation/setup technique in H.323).

Now, two different variants of messaging at call setup time according to the invention and how to implement them in a H.323 network will be described separately. However, as they have some common features, these features will be described described first.

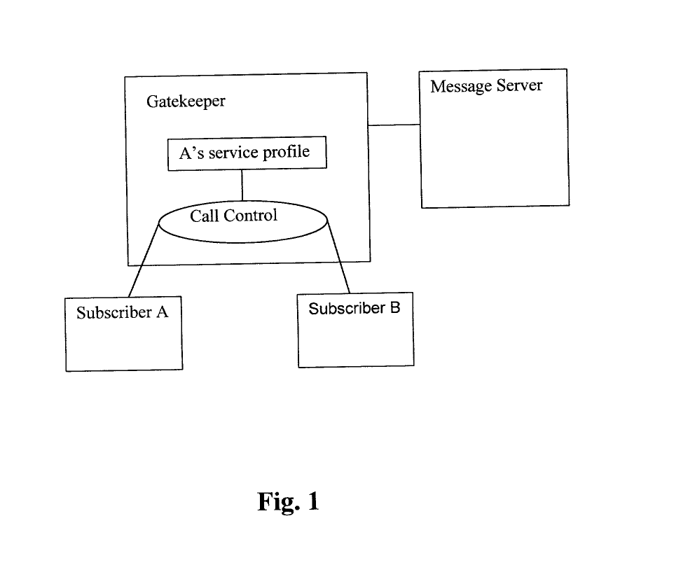

Commonly, the network will (simplified) look like what is shown in FIG. 1. The caller (A) will have a service profile stored in or available to the gatekeeper. In this service profile, different kinds of message triggers can be stored, e.g. identifiers for personal messages, commercial messages, general information from the service provider etc. The service provider updates the service profiles and enters messages into the message server, but the details of these aspects are not relevant to the present invention and are as such outside the scope of this disclosure.

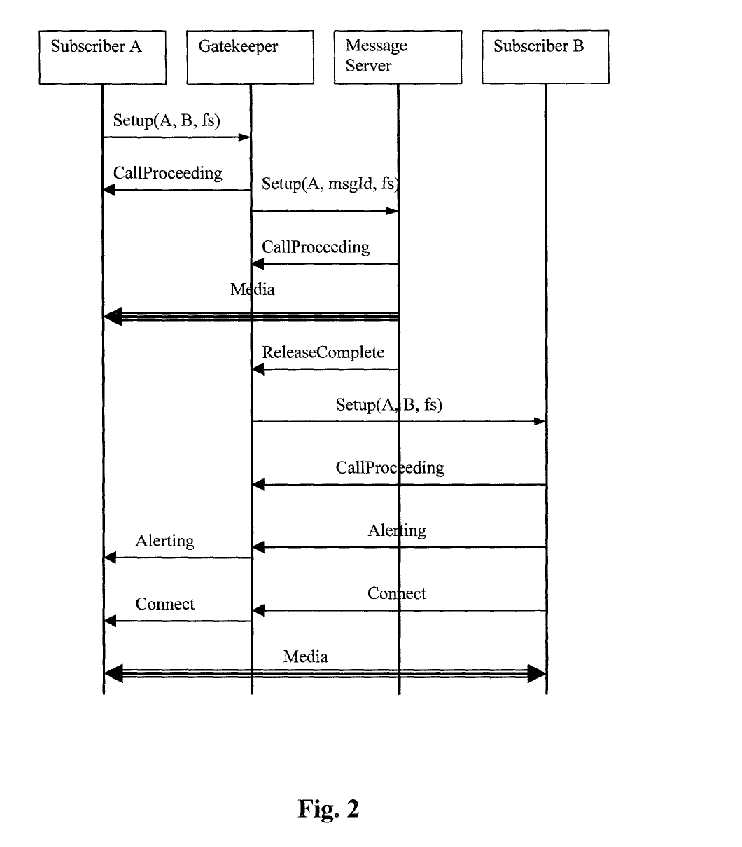

Now, firstly, and with reference ti FIG. 2, a first variant will be described wherein messaging prior to call establishment activities towards the called party is provided. In this example, the calling party has a message waiting.

A signal sequence diagram for a method according to the invention for providing messaging prior to call establishment is presented in FIG. 2. On the outset, subscriber A wants to make a call to B, and subscriber A sends a SETUP message including the calling and the called party numbers and the fast start elements describing A's media capabilities and the preferred capabilities for B. Upon receipt of the SETUP, the Gatekeeper will look into A's service profile and find that there is an indication of that A has some message waiting that should be sent to A before the normal call establishment is started. Based on information (e.g. personal message waiting, commercial is accepted etc) held in the service profile, the gatekeeper sends the SETUP to the Message Server. The Message Server starts sending the message (media type depends on the media capabilities in A's terminal). When the message is finished, the Message Server sends a RELEASECOMPLETE to the Gatekeeper, and the normal and well known call establishment procedure is resumed.

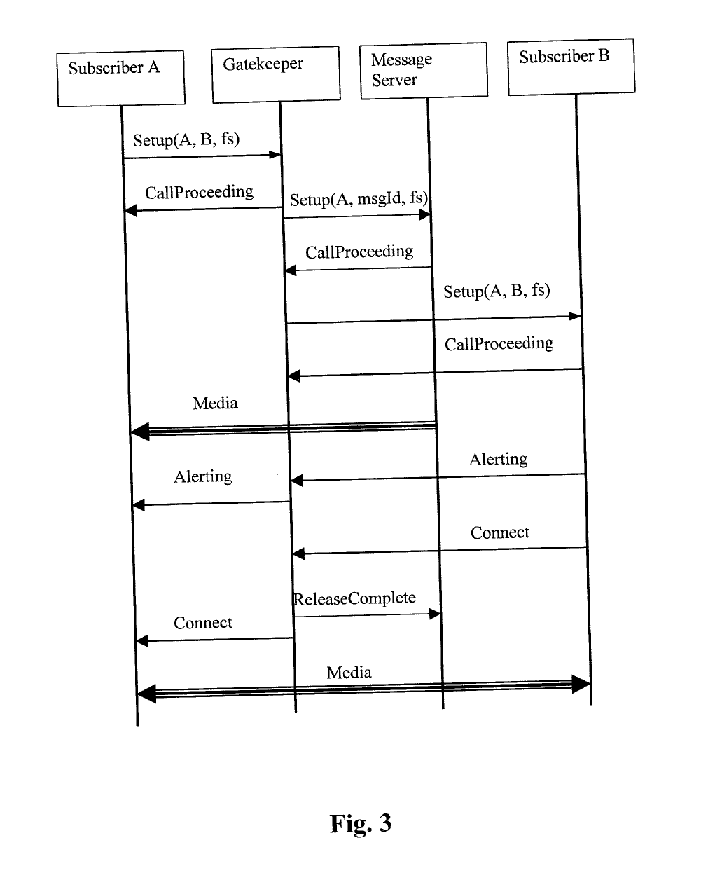

Now, with reference to FIG. 3, another variant will be described wherein messaging during call establishment is provided. In this example, the calling party (subscriber A) has a message waiting.

A signal sequence diagram for a method according to the invention for providing messaging during call establishment is presented in FIG. 3. Initially, the calling paty (here, subscriber A) requests a call setup as described in the previous example, and the Gatekeeper acts accordingly. However, in this case, based on information found in the service profile of the calling party (subscriber A), instead of waiting with the call establishment activities (described above for the variant providing messaging prior to call establishment) towards the called party (subscriber B), the Gatekeeper sends a SETUP to both the Message Server and subscriber B. The fast start of the SETUP towards B can contain a mediaWaitForConnect set to true to avoid that subscriber B and the Message Server send media at the same time. When the Gatekeeper receives a CONNECT from subcriber B, it sends a ReleaseComplete to the Message Server which ends the media sending, and then the CONNECT is sent to subscriber A.

In a third variant, messaging at call setup time can be a combination of the two previous variants, depending on information held in the service profile of the subscriber.

In a further aspect of the present invention, to be able to select the appropriate message to send to subscriber-A, the service profile of subscriber-A can be configured with a set of what could be best termed as ‘interest indicators’. Typical examples of such interest indicators are e.g. sport, travel or stocks. Thus, the SETUP sent to the Message Server, can contain a set of H.323 ID's in the destinationAddress that would serve as identifiers for interest indicators of subscriber A.

1. A method in a H.323 based network, said network being arranged to “fast start”, for initiating a message transfer in a messaging server destined for a calling subscriber before completing a call setup, said method comprising the steps of:
Sending from the calling subscriber a SETUP-message to a Gatekeeper associated with the caller to request a call setup;
characterised in the further steps of:
Searching, by the Gatekeeper, after receiving the SETUP message, a stored service profile of the calling subscriber for an indication of a message transfer to be initiated before completing the call setup; and,
if searching for the indication is successful:
Sending from the Gatekeeper, on basis of information in the service profile, a SETUP message to the messaging server, whereby the message transfer from the messaging server to the calling subscriber is initiated.

2. The method of claim 1, characterised in the further steps of:
Sending from the messaging server a RELEASECOMPLETE message to the Gatekeeper when the message transfer is completed;
sending, when the RELEASECOMPLETE message is received by the Gatekeeper, a SETUP message from the Gatekeeper to at least one called subscriber; and,
completing the call setup as requested by the calling subscriber.

3. The method of claim 1, characterised in the further steps of:
Sending, substantially at the time of sending the setup message to the messaging server, a SETUP message from the Gatekeeper to at least one called subscriber in accordance with the call setup request; and,
completing the call setup as requested by the calling subscriber.

4. The method of claim 1, characterised in the further steps of:
Sending, substantially at the time of sending the SETUP message to the messaging server, a SETUP message with a MediaWaitForConnect attribute set to true, from the Gatekeeper to at least one called subscriber according to the calle setup request; and,
completing the call setup as requested by the calling subscriber;
thereby avoiding sending of media from the at least one called subscriber to the calling subscriber at the time of message transfer.

5. A Gatekeeper, in a H.323 network, employing “Fast Start” for effecting call setup between calling and called subscribers (parties) according to H.323 version 2, said Gatekeeper including, or having access to, a storage storing at least one service profile of a subscriber, characterised in that:
The at least one service profile is adapted to include a first indication, said first indication indicating that a message transfer from the messaging server to the respective calling subscriber is to be initiated before completing a call setup requested by the respective subscriber.

6. A Gatekeeper according to claim 5, characterised in that the first indication further comprises:
A second indication, said second indication indicating that setup of a call requested by the respective subscriber is to be completed after completing the message transfer; or,
a third indication, said third indication indicating that media transfer in a completed call setup is to await completion of the message transfer; or,
a fourth indication indicating that setup of a call requested by the respective subscriber is to be completed after completing the message transfer and that media transfer in a completed call setup is to await completion of the message transfer.
